(19) United States
(12) Patent Application Publication
(10) Pub. No.: US 2024/0350844 A1
(43) Pub. Date: Oct. 24, 2024

(54) METHOD AND APPARATUS FOR HAZARD RESPONSE FOR BATTERY SYSTEM IN DATA CENTER

(71) Applicant: KAKAO CORP., Jeju-Si (KR)

(72) Inventor: Tae Hee Yu, Seongnam-Si (KR)

(21) Appl. No.: 18/639,412

(22) Filed: Apr. 18, 2024

(30) Foreign Application Priority Data
Apr. 21, 2023 (KR) 10-2023-0052919

(51) Int. Cl. A62C 3/16; A62C 37/36; H01M 10/48; H01M 10/613; H01M 10/627; H01M 10/633; H01M 10/6567

(52) U.S. Cl. CPC A62C 3/16; A62C 37/04; H01M 10/482; H01M 10/486; H01M 10/613; H01M 10/627; H01M 10/633; H01M 10/6567; H01M 2220/10

(57) ABSTRACT

A method and apparatus for responding to a fire hazard are disclosed. A method includes monitoring, based on sensing data from a plurality of fire hazard detection sensors configured to detect a fire hazard, a state of a plurality of battery cell sets in a battery system of a data center, detecting, based on the monitoring, a fire hazard state of at least one battery cell set of the plurality of battery cell sets, and controlling, by a controller and based on at least one triggering condition associated with the fire hazard state, a fire hazard response sequence corresponding to the at least one battery cell set. The fire hazard response sequence includes a series of operations comprising a power cut-off operation, an oxygen cut-off operation, and a cooling operation, and the cooling operation includes injecting, by the controller, a coolant in an inner portion of the battery system.

### CROSS-REFERENCE TO RELATED APPLICATIONS

This application claims priority under 35 USC § 119(a) to Korean Patent Application No. 10-2023-0052919 filed on Apr. 21, 2023, in the Korean Intellectual Property Office, the disclosure of which is incorporated by reference herein in its entirety.

### BACKGROUND

There is a growing need to develop a system that prevents hazards (e.g., fires) in facilities and automatically responds in case of a dangerous phenomenon because it may cause irreversible damage to facilities. To automatically detect and extinguish fires, various methods may be used, including a method of detecting smoke from a fire through a smoke detection sensor and automatically operating sprinklers and a method of attaching an automatic fire extinguishing patch that automatically sprays a fire extinguishing agent at a certain temperature or above. There is also a need to develop a system for effectively responding to fire to prevent large-scale damage by fires to facilities.

### SUMMARY

The following examples provide a fire response system in which a sequence for extinguishing a fire is automatically executed in case of a fire occurring in a battery including a plurality of battery cells.

The following examples provide a fire response system that controls a sequence of operations for responding to a fire according to triggering conditions to reduce damage to the entire battery.

However, technical aspects are not limited to the foregoing, and there may be other technical aspects.

A method may comprise: monitoring, based on sensing data from a plurality of fire hazard detection sensors configured to detect a fire hazard, a state of a plurality of battery cell sets in a battery system of a data center; detecting, based on the monitoring, a fire hazard state of at least one battery cell set of the plurality of battery cell sets; and controlling, by a controller and based on at least one triggering condition associated with the fire hazard state, a fire hazard response sequence corresponding to the at least one battery cell set, wherein the fire hazard response sequence comprises a series of operations comprising a power cut-off operation, an oxygen cut-off operation, and a cooling operation, and wherein the cooling operation comprises injecting, by the controller, a coolant in an inner portion of the battery system.

The controlling of the fire hazard response sequence may comprise: determining whether a plurality of triggering conditions respectively corresponding to the power cut-off operation, the oxygen cut-off operation, and the cooling operation comprised in the fire hazard response sequence are satisfied; and controlling, by the controller, an execution of an operation of the fire hazard response sequence corresponding to a satisfied triggering condition among the plurality of triggering conditions, and wherein the cooling operation comprises moving, by the controller, a waterproof sheet to surround at least the inner portion of the battery system, wherein the inner portion of the battery system surrounds at least a portion of the at least one battery cell set.

The controlling of the fire hazard response sequence may comprise: in response to the fire hazard state of the at least one battery cell set being detected, controlling a power cut-off operation of the at least one battery cell set and an oxygen cut-off operation of the at least one battery cell set.

The controlling of the fire hazard response sequence may comprise: based on an intensity of the fire hazard state reaching a first threshold intensity, controlling a fire extinguishing patch activation operation of the cooling operation for the at least one battery cell set.

The controlling of the fire hazard response sequence may comprise: based on the intensity of the fire hazard state reaching a second threshold intensity higher than the first threshold intensity, controlling at least one of a fire extinguishing agent spraying operation associated with the at least one battery cell set or a coolant injection operation associated with the at least one battery cell set.

The controlling of the fire hazard response sequence may comprise: based on a triggering condition for a fire extinguishing patch activation operation of the cooling operation being satisfied, controlling the fire extinguishing patch activation operation; and based on a duration of the fire hazard state reaching a threshold time, controlling at least one of a fire extinguishing agent spraying operation associated with the at least one battery cell set or a coolant injection operation associated with the at least one battery cell set.

An intensity of the fire hazard state may be determined based on at least one of a temperature or an amount of smoke around the at least one battery cell set.

The controlling of the fire hazard response sequence may comprise: controlling, based on whether a fire extinguishing agent corresponding to the battery cell set remains, the injecting of the coolant in the inner portion of the battery system.

The cooling operation may comprise a waterproof arrangement operation and a coolant injection operation, wherein the controlling of the fire hazard response sequence comprises: controlling the coolant injection operation based on whether the waterproof arrangement operation corresponding to the battery cell set is executed.

A battery cell set may comprise at least one of: a first unit comprising at least one battery cell; a second unit comprising at least one first unit; or a third unit comprising at least one second unit.

The oxygen cut-off operation may comprise at least one of: a flame-retardant cloth arrangement operation; or a fire extinguishing agent spraying operation.

The cooling operation may comprise at least one of: a fire extinguishing patch activation operation; a fire extinguishing agent spraying operation; a waterproof cloth arrangement operation; or a coolant injection operation.

The at least one triggering condition may comprise at least one of: a triggering condition corresponding to the detection of the fire hazard state; a triggering condition corresponding to an intensity of the fire hazard state; a triggering condition corresponding to a duration of the fire hazard state; or a triggering condition corresponding to whether a preceding operation in the fire hazard response sequence is executed.

The plurality of fire hazard detection sensors may comprise: an internal sensor of the at least one battery cell set; a heat detection sensor; a smoke detection sensor; and a thermal imaging camera.

A system may comprise: a plurality of fire hazard detection sensors configured to detect a fire hazard; a battery system, of a data center, comprising a plurality of battery cell sets; a controller; and a waterproof sheet configured to be movable by a control signal of the controller; and memory storing instructions that, when executed by the controller, cause the system to: monitor, based on sensing data from the plurality of fire hazard detection sensors, a state of the plurality of battery cell sets in the battery system; detect, based on monitoring the state of the plurality of battery cell sets, a fire hazard state of at least one battery cell set of the plurality of battery cell sets; and control, based on at least one triggering condition associated with the fire hazard state, a fire hazard response sequence corresponding to the at least one battery cell set, wherein the fire hazard response sequence comprises a series of operations comprising a power cut-off operation, an oxygen cut-off operation, and a cooling operation, and wherein the cooling operation comprises injecting, by the controller, a coolant in an inner portion of the battery system.

The plurality of fire hazard detection sensors may comprise: an internal sensor of the at least one battery cell set; a heat detection sensor; a smoke detection sensor; and a thermal imaging camera.

The instructions, when executed by the controller, may cause the system to control the fire hazard response sequence by: determining whether the plurality of triggering conditions respectively corresponding to the power cut-off operation, the oxygen cut-off operation, and the cooling operation comprised in the fire hazard response sequence are satisfied; and controlling an execution of an operation of the fire hazard response sequence corresponding to a satisfied triggering condition among the plurality of triggering conditions, and wherein the cooling operation comprises moving, by the controller, a waterproof sheet to surround at least the inner portion of the battery system, wherein the inner portion of the battery system surrounds at least a portion of the at least one battery cell set.

The instructions, when executed by the controller, may cause the system to control the fire hazard response sequence by: in response to the fire hazard state of the at least one battery cell set being detected, controlling a power cut-off operation of the at least one battery cell set and an oxygen cut-off operation of the at least one battery cell set.

The instructions, when executed by the controller, may cause the system to control the fire hazard response sequence by: based on an intensity of the fire hazard state reaching a first threshold intensity, controlling a fire extinguishing patch activation operation of the cooling operation for the at least one battery cell set.

The instructions, when executed by the controller, may cause the system to control the fire hazard response sequence by: based on the intensity of the fire hazard state reaching a second threshold intensity higher than the first threshold intensity, controlling at least one of a fire extinguishing agent spraying operation associated with the at least one battery cell set or a coolant injection operation associated with the at least one battery cell set.

A non-transitory computer-readable medium may store instructions that, when executed by one or more processors, cause one or more devices to perform one or more methods described herein.

A server may comprise: a processor configured to: monitor a state of a battery cell set based on a plurality of fire detection sensors; detect a fire state of the battery cell set based on at least one of the fire detection sensors; and control a fire response sequence corresponding to the battery cell set, based on triggering conditions corresponding to the fire state, wherein the fire response sequence comprises a series of operations comprising a power cut-off operation, an oxygen cut-off operation, and a cooling operation to extinguish a fire in the battery cell set.

For controlling the fire response sequence, the processor may be configured to: determine whether the triggering conditions respectively corresponding to the power cut-off operation, the oxygen cut-off operation, and the cooling operation comprised in the fire response sequence are satisfied; and control an execution of an operation in the fire response sequence corresponding to a satisfied triggering condition among the triggering conditions.

For controlling the fire response sequence, the processor may be configured to: in response to the fire state of the battery cell set being detected, control the power cut-off operation of the battery cell set and the oxygen cut-off operation corresponding to the battery cell set.

For controlling the fire response sequence, the processor may be configured to: when an intensity of the fire state reaches a first threshold intensity, control a fire extinguishing patch activation operation in the cooling operation corresponding to the battery cell set.

For controlling the fire response sequence, the processor may be configured to: when the intensity of the fire state reaches a second threshold intensity higher than the first threshold intensity, control at least one of a fire extinguishing agent spraying operation or a coolant injection operation in the cooling operation corresponding to the battery cell set.

### BRIEF DESCRIPTION OF THE DRAWINGS

The above and other features of certain embodiment(s) of the present disclosure will be more apparent from the following detailed description, taken in conjunction with the accompanying drawings, in which:

FIG. 1 is a diagram illustrating an example fire response system;

FIG. 2 is a diagram illustrating an example battery cell set;

FIG. 3 is a diagram illustrating an example fire response module installed in each battery cell set;

FIG. 4 is a flowchart illustrating an example fire response method;

FIG. 5 is a diagram illustrating an example fire response sequence;

FIG. 6 is a flowchart illustrating an example process in which a fire response sequence is executed based on triggering conditions; and

FIG. 7 is a diagram illustrating an example of the application of a fire response system.

FIG. 8 shows an example of a battery device associated with a fire response system.

### DETAILED DESCRIPTION

The following detailed structural or functional description is provided only for the purpose of providing examples, and various alterations and modifications may be made to the examples. Here, the examples are not construed as limited to the disclosure and should be understood to include all changes, equivalents, and replacements within the idea and the technical scope of the disclosure. Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

In the present disclosure, a device may be configured to include one or more devices (e.g., one or more sub-devices coupled to each other to constitute at least part of the device that includes the one or more sub-devices) and/or one or more modules (e.g., one or more hardware modules and/or one or more software modules implemented by one or more instructions stored in memory and may be executed by one or more processors).

Hereinafter, embodiment(s) will be described in detail with reference to the accompanying drawings. When describing the embodiments with reference to the accompanying drawings, like reference numerals refer to like components and a repeated description related thereto will be omitted.

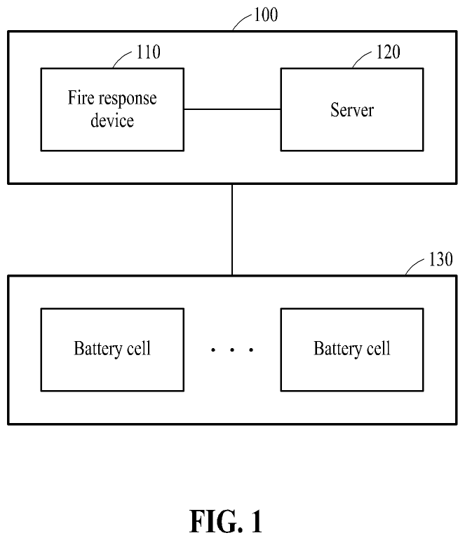

FIG. 1 is a diagram illustrating an example fire response system.

Referring to FIG. 1, a fire response system 100 may include a fire response device 110 and a server 120 configured to control the fire response device 110. The fire response system 100 may detect an occurrence of a fire in a battery cell set 130 and perform a fire response operation corresponding to the battery cell set 130.

The server 120 may determine a fire state of the battery cell set 130 and control an operation of the fire response device 110 for responding to afire. For example, the server 120 may determine the fire state of the battery cell set 130 based on data received from the fire response device 110. The server 120 may transmit a control signal to the fire response device 110 such that an operation for responding to a fire is to be performed on the battery cell set 130 in which a fire is determined to have occurred. A method of operating the server 120 to respond to a fire will be described in detail below.

The fire response device 110, which may refer to a device configured to detect an occurrence of a fire in a battery cell set and perform an operation for responding to the fire, may include, for example, a fire detection sensor, a device for cutting off power to the battery cell set, a device for cutting off oxygen to the battery cell set, and a device for cooling. The fire response device 110 may include one or more sensors for detecting an occurrence of a fire on one or more battery cells, and/or detecting a potential hazard of one or more battery cells. The one or more sensors may include at least one of: a thermal sensor, a gas sensor, a smoke detector, a voltage sensor, a current sensor, a power sensor, a fire alarm, a light-emitting diode (LED) indicator, etc. The fire response device 110 may include one or more switches that may cut off power to one or more of the battery cells of the battery cell set. For example, the device for cutting off oxygen may include a flame-retardant cloth arrangement device. For example, the device for cooling may include at least one of a waterproof cloth arrangement device, a coolant injection device, or a fire extinguishing patch and fire extinguishing agent spraying device, etc. If the fire extinguishing patch and/or fire extinguishing agent spraying device performs an oxygen cut-off function, which is a function for cutting off oxygen, it may correspond to the device for cutting off oxygen.

The fire response device 110 may include a battery management system (BMS). The BMS may include a system that measures various factors such as current, voltage, and temperature of a battery cell using sensors to control a charging state, a discharging state, and a remaining amount of the battery cell.

A battery cell, a basic unit of a battery usable through the charging and discharging of electrical energy, may include, for example, a basic unit of a lithium-ion battery or any other types of battery (e.g., a solid state battery, etc.). The battery cell set 130 may include one or more battery cells and may correspond to a unit for fire detection and fire response.

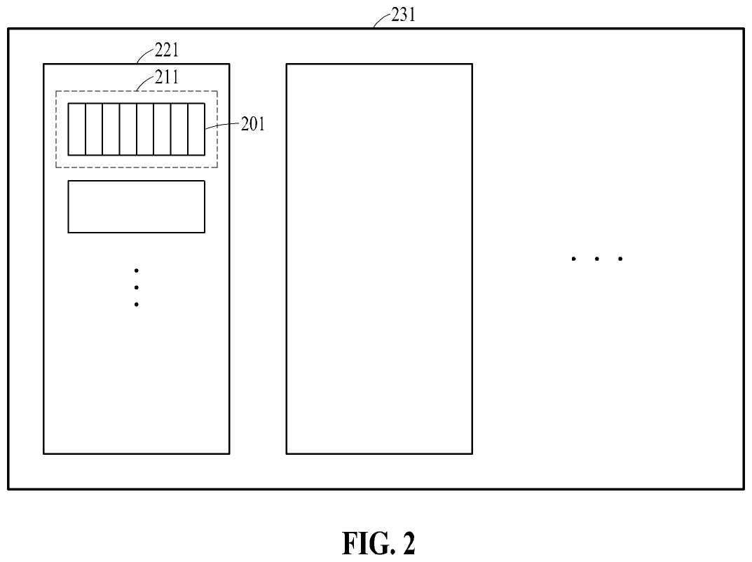

For example, referring to FIG. 2, a first unit 211 of a battery may correspond to a set of one or more battery cells 201, a second unit 221 may correspond to a set of one or more first units 211, and a third unit 231 may correspond to a set of one or more second units 221. A battery cell set described herein may include at least one of the first unit 211, the second unit 221, or the third unit 231. For example, the first unit 211 may also be referred to as a battery module, the second unit 221 may also be referred to as a battery pack or battery rack, and the third unit 231 may also be referred to as a battery casing.

Referring again to FIG. 1, the fire response system 100 may operate based on a unit of battery module, battery rack, or battery casing. For example, the fire response system 100 may detect a hazard or a fire that has occurred in a first battery rack and may perform a fire response operation on the first battery rack where the fire has occurred.

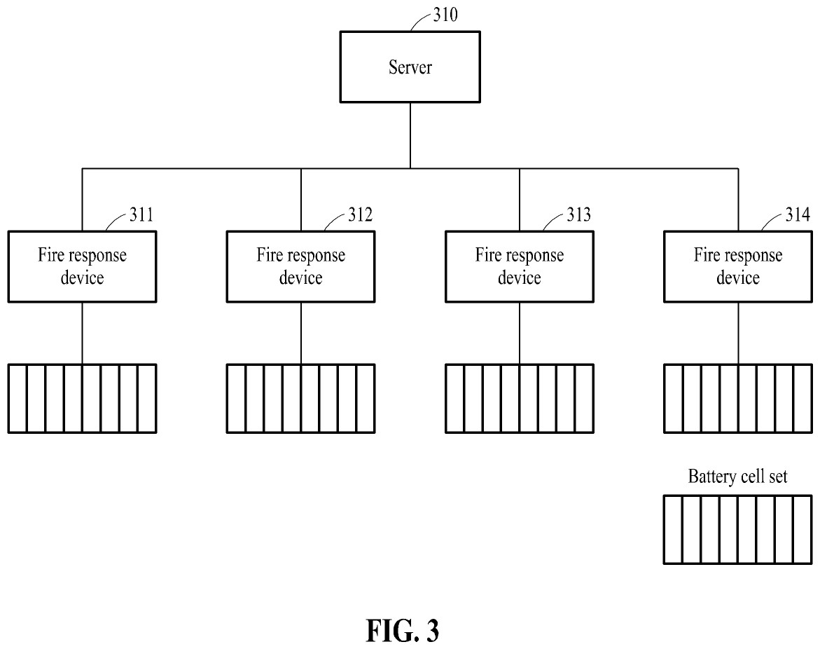

FIG. 3 is a diagram illustrating an example fire response module installed in each battery cell set.

Referring to FIG. 3, fire response devices 311, 312, 313, and 314 may be installed in respective battery cell sets. For example, a hazard detection sensor and/or a fire detection sensor may be installed in each battery cell set. A server 310 may monitor a state of each battery cell set based on data received from the hazard detection sensor and/or the fire detection sensor installed in each battery cell set and may thereby detect a hazard state and/or a fire state of each battery cell set. The fire response modules 311, 312, 313, and 314 shown in FIG. 3 may correspond to the fire response device 110 described above with reference to FIG. 1, and the server 310 may correspond to the server 120 described above with reference to FIG. 1.

The hazard detection sensor and/or the fire detection sensor, which may include a sensor that detects a hazard and/or a fire in at least a portion of a battery cell set, may include, for example, at least one of an internal sensor of the battery cell set, a heat detection sensor, a smoke detection sensor, or a thermal imaging camera.

The fire detection sensor may include a plurality of fire detection sensors. The plurality of fire detection sensors may include a plurality of fire detection sensors of different types. For example, the plurality of fire detection sensors may include two or more sensors among the internal sensor of the battery cell set, the heat detection sensor, the smoke detection sensor, and the thermal imaging camera. In this case, data sensed by two or more types of the fire detection sensors may be transmitted to the server 310.

The server 310 may monitor a state of each battery cell set based on data received from the fire detection sensor. The state of a battery cell set to be monitored may include at least one of a temperature of the battery cell set, an ambient temperature of the battery cell set, or an amount of smoke generated around the battery cell set.

The server 310 may detect a fire state of each battery cell set based on the data received from the fire detection sensor. The fire state may include at least one of information about the intensity of the fire state or information about the duration of the fire state.

The fire detection sensor may be installed in each battery cell set or may be installed in the entire battery including the battery cell sets. For example, in the case of the thermal imaging camera, at least one thermal imaging camera that captures images of the entire battery may be installed, rather than installed for each battery cell set. The server 310 may determine a portion in the battery where a hazard and/or a fire has detected and/or occurred based on a result of capturing an image by the thermal imaging camera. The server 310 may determine, as the fire state, a state of a battery cell set including the portion where the hazard and/or the fire has been detected or occurred.

The fire response devices 311, 312, 313, and 314 each including a device for cutting off power, a device for cutting off oxygen, and a device for cooling may be installed for respective battery cell sets (e.g., to extinguish a fire and/or to prevent a hazard, fire, etc.).

The device for cutting off power may perform an operation for cutting off power to be supplied to a battery cell set (e.g., one or more batteries being in the fire state or in a dangerous state).

For example, the device for cooling may include at least one of a fire extinguishing patch and fire extinguishing agent spraying device or a coolant injection device. When activated, a fire extinguishing patch may act on each battery cell set as a unit. The fire extinguishing agent spraying device may control a spraying range such that a fire extinguishing agent is to be sprayed on a specific battery cell set. The coolant injection device may control the injection of coolant such that a specific battery cell set is immersed in the coolant. Alternatively or additionally, the coolant injection device may control a position of a space containing the coolant and/or a position of a specific battery cell set such that the specific battery cell set is immersed in the space containing the coolant.

For example, the device for cooling may include a waterproof cloth arrangement device. A waterproof cloth may be arranged on a battery cell set where an occurrence of a fire is detected. The arrangement of the waterproof cloth may prevent the coolant sprayed on a battery cell set from leaking out and prevent the coolant from being sprayed onto other battery cell sets.

For example, the device for cutting off oxygen may include a flame-retardant cloth arrangement device. A flame-retardant cloth may be arranged on a battery cell set where an occurrence of a fire is detected. The arrangement of the flame-retardant cloth may prevent oxygen from entering a space where a fire has occurred, thereby allowing the fire to be extinguished. In addition, the arrangement of the flame-retardant cloth may prevent a fire from spreading to other battery cell sets.

As the fire response system operates for each battery cell set as a unit, a fire may be prevented from spreading to another unit of a battery cell set. In addition, spraying the fire extinguishing agent or injecting the coolant, which may cause damage to battery cells, may have a range limited to a battery cell set where a fire has occurred, thereby reducing damage to battery cells.

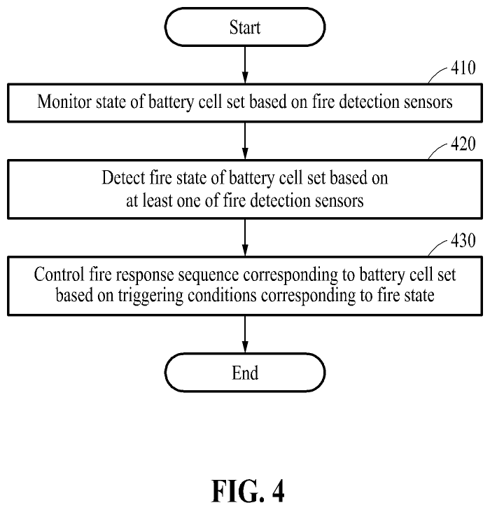

FIG. 4 is a flowchart illustrating an example fire response method.

A fire response method may be performed by a server (and/or a fire response device, such as the fire response device described herein) for responding to a fire in a battery cell. For example, the server may correspond to the server 110 described above with reference to FIG. 1 and the server 310 described above with reference to FIG. 3. The server may interwork with a fire response device for responding to a fire. The server may generate a signal for controlling an operation of the fire response device. The signal generated by the server may be transmitted to the fire response device. The server may interwork with a battery cell set. The server may generate a signal for controlling an operation of the battery cell set. The signal generated by the server may be transmitted to the battery cell set.

Referring to FIG. 4, the fire response method may include operation 410 of monitoring a state of a battery cell set based on a plurality of fire detection sensors.

The server may monitor the state of the battery cell set based on data received from the plurality of fire detection sensors. The plurality of fire detection sensors may include different types of fire detection sensors. For example, the plurality of fire detection sensors may include two or more sensors among an internal sensor of the battery cell set, a heat detection sensor, a smoke detection sensor, and a thermal imaging camera.

The state of a battery cell set to be monitored may include at least one of a temperature of the battery cell set, an ambient temperature of the battery cell set, or an amount of smoke generated around the battery cell set. For example, the server may monitor the state of the battery cell set to determine whether a fire has occurred in the battery cell set, based on the data received from the plurality of fire detection sensors.

The fire response method may include operation 420 of detecting a fire state of the battery cell set based on at least one of the fire detection sensors. The server may detect the fire state of the battery cell set based on data received from at least one of the plurality of fire detection sensors.

The fire state may be detected based on the temperature and/or amount of smoke around the battery cell set received from at least one of the fire detection sensors. For example, when data indicating a temperature of a battery cell set received from an internal sensor of the battery cell set indicates a temperature higher than a threshold temperature, the server may detect the fire state of the battery cell set. The threshold temperature may correspond to a predetermined temperature value at which afire is determined to have occurred. For example, when data indicating an amount of smoke around a battery cell set received from a smoke detection sensor of the battery cell set indicates a threshold amount of smoke or more, the server may detect the fire state of the battery cell set. The threshold amount of smoke may correspond to a predetermined smoke amount value at which a fire is determined to have occurred.

The server may determine at least one of the intensity of the fire state of the battery cell set or the duration of the fire state based on the data received from the at least one of the fire detection sensors. The intensity of the fire state may be determined based on at least one of the temperature or the amount of smoke around the battery cell set. The higher the temperature around the battery cell set, the higher the intensity of the fire state may be determined. For example, the intensity of the fire state may include a first value corresponding to a case where the temperature around the battery cell set reaches a first threshold temperature and a second value corresponding to a case where the temperature around the battery cell set reaches a second threshold temperature. If the second threshold temperature is higher than the first threshold temperature, the second value may indicate a higher intensity than the first value. The greater the amount of smoke detected in the battery cell set, the higher the intensity of the fire state may be determined.

The fire state may include information indicating the duration of the fire state. The information indicating the duration of the fire state may include information indicating the duration of a state in which a fire continues. For example, information indicating the duration of the fire state may include information indicating the duration of a state in which a fire of a specific intensity continues. For example, if the intensity of the fire state includes a first intensity and a second intensity, the information indicating the duration of the fire state may include information indicating the duration of the first intensity and information indicating the duration of the second intensity. For example, the information indicating the duration of the fire state may include information indicating the duration of the fire state by temperature. For example, the information indicating the duration of the fire state may include a temperature graph indicating a temperature of a battery cell set over time.

The fire response method may include operation 430 of controlling a fire response sequence corresponding to the battery cell set based on triggering conditions corresponding to the fire state.

The fire response sequence may include a series of operations to be performed to extinguish a fire in a battery cell set where the fire is determined to have occurred. For example, the fire response sequence may include a series of operations including, for example, a power cut-off operation, an oxygen cut-off operation, and a cooling operation, to extinguish the fire in the battery cell set.

The oxygen cut-off operation and the cooling operation may each include one or more detailed operations. For example, the oxygen cut-off operation may include at least one of a flame-retardant cloth arrangement operation or a fire extinguishing agent spraying operation. For example, the cooling operation may include at least one of a fire extinguishing patch activation operation, a fire extinguishing agent spraying operation, and/or a coolant injection operation. If the cooling operation includes the coolant injection operation, a waterproof cloth arrangement operation may be performed before the coolant injection operation.

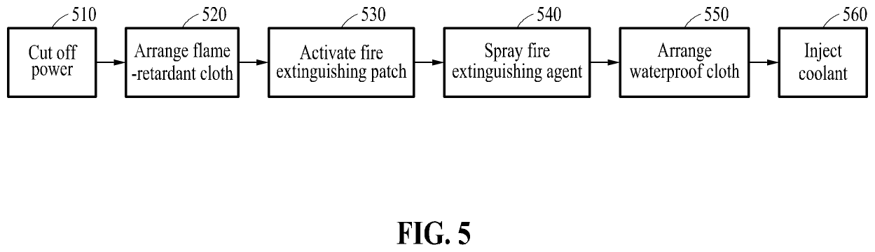

The fire response sequence may include a sequence of at least one operation of the power cut-off operation, at least one operation of the oxygen cut-off operation, and at least one operation of the cooling operation. For example, referring to FIG. 5, the fire response sequence may include a sequence of one or more operations among a power cut-off operation 510, a flame-retardant cloth arrangement operation 520, a fire extinguishing patch activation operation 530, a fire extinguishing agent spraying operation 540, a waterproof cloth arrangement operation 550, and a coolant injection operation 560 to be performed on a battery cell set.

The coolant injection operation 560 may include an operation of immersing a battery cell set. For example, the coolant injection operation 560 may include an operation of filling water into a space where the battery cell set is disposed to allow the battery cell set to be immersed in water or any other liquid that may prevent the hazard. For example, the coolant injection operation 560 may include an operation of immersing the battery cell set in a space filled with coolant.

FIG. 5 illustrates only an example of the fire response sequence, and the fire response sequence is not limited thereto. The fire response sequence may include some of the operations shown in FIG. 5, and the sequence of operations may be performed in a different order from that shown in FIG. 5. For example, the fire response sequence may change depending on the intensity of a fire state. For example, in a case in which the intensity of the fire state increases rapidly beyond a threshold speed or is determined to be high intensity, the fire extinguishing agent spraying operation and the coolant injection operation may be executed first to quickly extinguish a fire. For example, the fire response sequence may change depending on the number of battery cell sets in which a fire occurs. For example, if the number of battery cell sets in which a fire occurs exceeds a threshold value, the fire extinguishing agent spraying operation and the coolant injection operation may be executed first.

The triggering conditions may be conditions that trigger operations of the fire response sequence and may include at least one of, for example, a triggering condition corresponding to the detection of a fire state, a triggering condition corresponding to the intensity of the fire state, a triggering condition corresponding to the duration of the fire state, and/or a triggering condition corresponding to whether a preceding operation in the fire response sequence is executed. For example, a triggering condition for a specific operation may include a condition for triggering the operation when a fire is detected. For example, a triggering condition for a specific operation may include a condition for triggering the operation when the intensity of a fire state reaches a threshold intensity. For example, a triggering condition for a specific operation may include a condition for triggering the operation when the duration of a fire state reaches a threshold time. For example, a triggering condition for a specific operation may include a condition for triggering the operation when a preceding operation in the fire response sequence is executed.

Referring again to FIG. 4, operation 430 of controlling the fire response sequence may include an operation of determining whether the triggering conditions respectively corresponding to the power cut-off operation, the oxygen cut-off operation, and the cooling operation included in the fire response sequence are satisfied, and an operation of executing an operation in the fire response sequence corresponding to a satisfied triggering condition. For example, if a triggering condition corresponding to the power cut-off operation is satisfied, the power cut-off operation may be performed. For example, if a triggering condition corresponding to the oxygen cut-off operation is satisfied, the oxygen cut-off operation may be performed. For example, if a triggering condition corresponding to the cooling operation is satisfied, the cooling operation may be performed.

Operation 430 of controlling the fire response sequence 430 may include an operation of controlling the power cut-off operation of the battery cell set in response to the detection of the fire state of the battery cell set.

Operation 430 of controlling the fire response sequence may include an operation of controlling the oxygen cut-off operation corresponding to the battery cell set in response to the detection of the fire state of the battery cell set. For example, the oxygen cut-off operation may include a flame-retardant cloth arrangement operation.

If an occurrence of a fire is detected in a battery cell set, the server may control a fire response device or battery cells to execute at least one of the power cut-off operation for cutting off power to the battery cell set or the oxygen cut-off operation for cutting off oxygen to the battery cell set. For example, the server may transmit a control signal for cutting off current to a battery cell included in the battery cell set. For example, the server may transmit a control signal to the fire response device for cutting off oxygen such that oxygen is to be cut off around the battery cell set where afire occurs. For example, when the fire response device for cutting off oxygen is installed in each battery cell set, a control signal for cutting off oxygen may be transmitted to a fire response device corresponding to a battery cell set in which a fire is determined to have occurred.

If an operation included in the fire response sequence includes one or more detailed operations, whether a triggering condition corresponding to each of the detailed operations is satisfied may be determined, and a detailed operation corresponding to the satisfied triggering condition may be performed. For example, the cooling operation may include at least one of a fire extinguishing patch activation operation, a fire extinguishing agent spraying operation, a waterproof cloth arrangement operation, and/or a coolant injection operation.

If the intensity of the fire state reaches a first threshold intensity, operation 430 of controlling the fire response sequence may include an operation of controlling the fire extinguishing patch activation operation corresponding to a battery cell set during the cooling operation. For example, if it is determined that the intensity of the fire state of the battery cell set has reached the first threshold intensity, the server may transmit a control signal to a fire extinguishing patch to activate the fire extinguishing patch corresponding to the battery cell set. The fire extinguishing patch corresponding to the battery cell set may be activated by the control signal (e.g., an activation signal) received from the server. For example, the first threshold intensity may be an intensity corresponding to a temperature of 60 degrees Celsius (° C.) around the battery cell set.

The fire extinguishing patch may include an automatic fire extinguishing patch that automatically operates above a set temperature. The automatic fire extinguishing patch may operate automatically above the set temperature without a control signal.

The fire extinguishing agent spraying operation or the coolant injection operation during the cooling operation may be controlled to be executed after the fire extinguishing patch operates. When the fire extinguishing patch operates, the battery cell set may be reusable, but may not be reusable once the coolant or the fire extinguishing agent is sprayed thereon. Accordingly, to increase the reusability of a battery cell set after responding to a fire, the fire response sequence may be controlled such that the fire extinguishing patch operates prior to the coolant injection operation or the fire extinguishing agent spraying operation.

For example, if a triggering condition for the fire extinguishing patch activation operation is satisfied, operation 430 of controlling the fire response sequence may include an operation of controlling the fire extinguishing patch activation operation, and if the duration of the fire state reaches the threshold time, operation 430 of controlling the fire response sequence may include an operation of controlling at least one of the fire extinguishing agent spraying operation or the coolant injection operation corresponding to the battery cell set.

If the fire extinguishing patch operates first, and even after the fire extinguishing patch operates, a fire is not extinguished and the fire state does not change to a fire end state but continues for the threshold time or more, the fire response device may be controlled such that at least one of the fire extinguishing agent or the coolant is sprayed.

If the intensity of the fire state reaches a second threshold intensity higher than the threshold intensity at which the fire extinguishing patch operates, operation 430 of controlling the fire response sequence may include an operation of controlling at least one of the fire extinguishing agent spraying operation or the coolant injection operation corresponding to the battery cell set. As described above, the intensity of the fire state may be determined based on at least one of a temperature around the battery cell set or an amount of smoke generated around the battery cell set.

For example, if the threshold intensity at which the fire extinguishing patch operates is the intensity corresponding to a first temperature or a first temperature range (e.g., a temperature of 60° C.) around the battery cell set, the second threshold intensity may be the intensity corresponding to a second temperature or a second temperature range (e.g., a temperature of 80° C.) around the battery cell set.

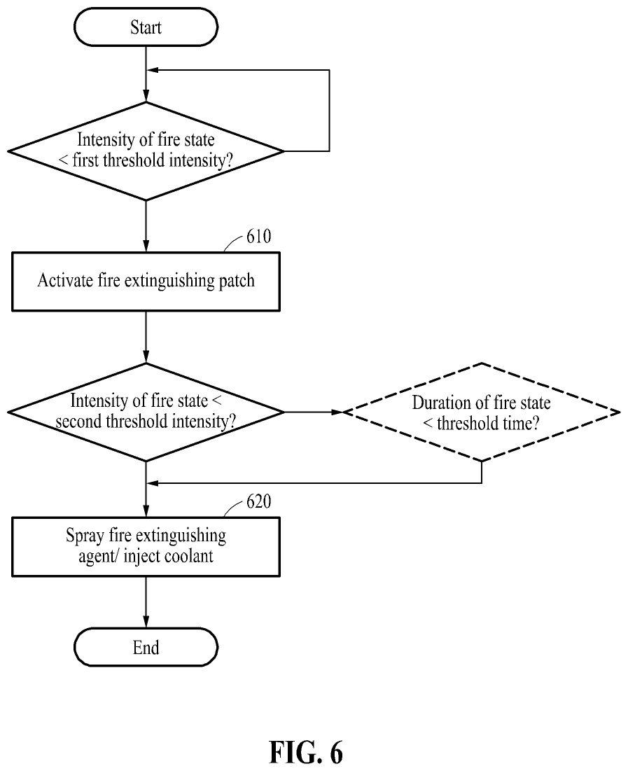

An example of executing the fire extinguishing patch activation operation, the fire extinguishing agent spraying operation, and the coolant injection operation according to the triggering conditions will be described in detail below with reference to FIG. 6.

Referring to FIG. 6, when the intensity of the fire state corresponding to the battery cell set exceeds the first threshold intensity, a fire extinguishing patch activation operation 610 may be executed. In this case, a fire extinguishing patch may be activated by a fire extinguishing patch activation control signal transmitted from the server or may be activated automatically by detecting the arrival at a threshold fire intensity (e.g., threshold temperature).

If the intensity of the fire state reaches the second threshold intensity after the fire extinguishing patch activation operation 610 is executed, the server may transmit a control signal to the fire response device such that at least one of a fire extinguishing agent or coolant is sprayed. By the control signal transmitted from the server, a fire extinguishing agent spraying operation and/or coolant injection operation 620 may be executed.

If the intensity of the fire state does not reach the second threshold intensity after the fire extinguishing patch is activated in operation 610, the execution of the operations of the fire response sequence may be suspended based on whether the fire state ends. For example, if the duration of the fire state of the first threshold intensity exceeds the threshold time although the intensity of the fire state does not reach the second threshold intensity, the server may determine that the fire state does not end. If it is determined that the fire state has not ended, the server may control the fire response device such that at least one of the fire extinguishing agent or the coolant is sprayed. For example, if the intensity of the fire state has not reached the second threshold intensity, but the duration of the fire state of the first threshold intensity exceeds the threshold time, the fire extinguishing agent spraying operation and/or the coolant injection operation 620 may be executed.

Referring again to FIG. 4, operation 430 of controlling the fire response sequence may include an operation of controlling the coolant injection operation corresponding to the battery cell set based on whether the fire extinguishing agent corresponding to the battery cell set remains. For example, the server may control the fire response device such that the fire extinguishing agent is sprayed preferentially over the coolant. If there is no remaining amount of the fire extinguishing agent stored in the fire response device, the server may control the fire response device such that the coolant is sprayed.

Pipelines through which the fire extinguishing agent and the coolant are sprayed may be the same or different from each other. If the pipelines through which the fire extinguishing agent and the coolant are sprayed are the same, the fire response device for injecting the fire extinguishing agent and the coolant may operate such that the fire extinguishing agent and the coolant are sprayed according to a predetermined order. For example, the fire response device for injecting the fire extinguishing agent and the coolant may operate such that the fire extinguishing agent is sprayed first and the coolant is then injected after the stored fire extinguishing agent is all sprayed. If the pipelines through which the fire extinguishing agent and the coolant are sprayed are different, the spraying of the fire extinguishing agent and the injection of the coolant may be controlled independently of each other according to a control signal.

Operation 430 of controlling the fire response sequence may include an operation of controlling the coolant injection operation based on whether the waterproof cloth arrangement operation corresponding to the battery cell set is executed. For example, a triggering condition for the coolant injection operation may include a condition corresponding to the fire state and a condition corresponding to whether a preceding operation is executed. The coolant injection operation may be triggered when the condition corresponding to the fire state is satisfied and the execution of the waterproof cloth arrangement operation, which is the preceding operation, is completed. For example, the waterproof cloth arrangement operation may be performed (e.g., simultaneously) with the fire-retardant cloth arrangement operation corresponding to the oxygen cut-off operation.

As the fire response sequence is controlled such that the waterproof cloth is arranged first before the coolant injection operation is performed, the coolant may be prevented from being sprayed onto another battery cell where a fire does not occur.

The server may include a processor, a memory, and a communication device. The processor of the server may perform at least one of the operations described above with reference to FIGS. 1 to 6. For example, the processor may perform at least one of an operation of monitoring a state of a battery cell set based on a plurality of fire detection sensors, an operation of determining a fire state of the battery cell set based on at least one of the fire detection sensors, or an operation of controlling a fire response sequence corresponding to the battery cell set based on triggering conditions corresponding to the fire state.

The memory of the server may be a volatile memory or a non-volatile memory and may store data related to the fire response method described above with reference to FIGS. 1 to 6. For example, the memory may store data generated in a process of performing the fire response method or data required to perform the fire response method. For example, the memory may store a control signal (or command) for executing the fire response sequence and a triggering condition set in response to each operation in the fire response sequence.

The communication device of the server (e.g., wired and/or wireless communication interfaces, etc.) may enable the server to communicate with other electronic devices or other servers through a network. In an example, the server may be connected to an external device and exchange data therewith through the communication device. For example, the server may transmit and receive data with a fire response device (e.g., the fire response device 110 of FIG. 1) and a battery cell set (e.g., the battery cell set 130 of FIG. 1) or battery cells, which are included in a fire response system (e.g., the system 100 of FIG. 1), through the communication device.

The memory of the server may store a program implementing the fire response method described above with reference to FIGS. 1 to 6. The processor of the server may execute the program stored in the memory of the server and control the server. A code of the program executed by the processor of the server may be stored in the memory of the server.

The server may further include other components not shown. For example, the server may further include an input/output interface including an input device and an output device as a means for interfacing with the communication device. For example, the server may further include other components such as a transceiver, various sensors, and a database (DB).

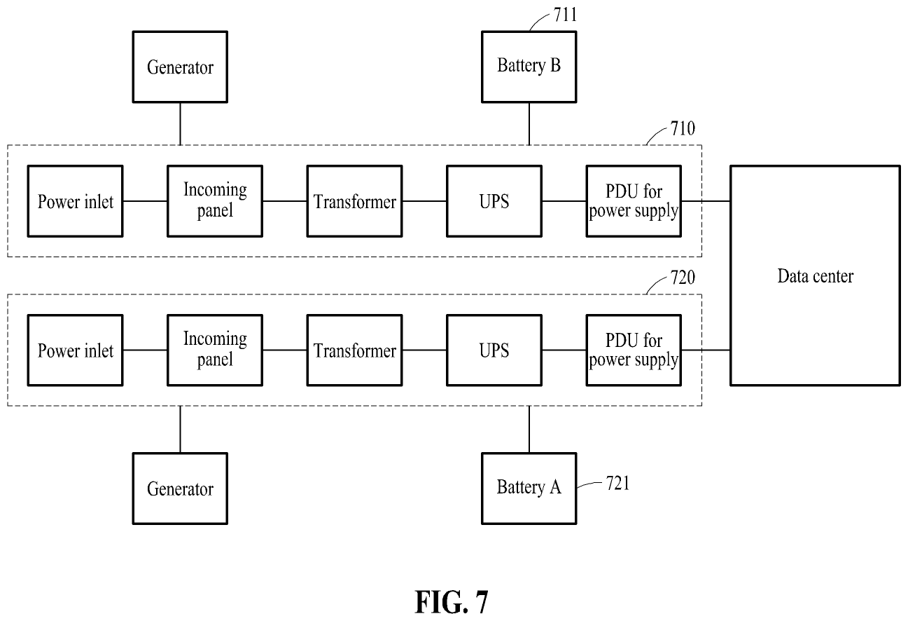

FIG. 7 is a diagram illustrating an example of the application of a fire response system.

Referring to FIG. 7, a fire response system may be applied to batteries 711 and 721 used to supply power to a data center 701. For example, a power supply device of the data center 701 may include a first power supply device 710 and a second power supply device 720 that operate independently of each other. The batteries 711 and 721 to which the fire response system is applied may include a first battery 711 for backup power of the first power supply device 710 and a second battery 721 for backup power of the second power supply device 720.

A server of the fire response system, which is the server described above with reference to FIGS. 1 to 6, may perform a fire response operation described above with reference to FIGS. 1 to 6 to respond to a fire in each of the first battery 711 and the second battery 721. For example, the server may monitor a fire state corresponding to each of a battery cell set in the first battery 711 and a battery cell set in the second battery 721 based on data received from a fire detection sensor. If it is determined that a fire has occurred in a battery cell set, the server may control a fire response device to perform a fire response sequence corresponding to the battery cell set.

For example, if a hazard is detected and/or a fire occurs in the first battery 711, power to a battery cell set in the first battery 711 where the hazard is detected and/or the fire occurs may be cut off by the fire response operation. Even when power to some battery cells in the first battery 711 is cut off, power may be stably supplied to the data center 701 by the second power supply device 720.

For example, if a hazard is detected and/or a fire occurs in the first battery 711 and the fire response sequence is performed, a battery cell set in which the hazard is detected and/or the fire occurs in the first battery 711 may be damaged. Even when the battery cell set in which the hazard is detected and/or the fire occurs is damaged, other battery cell sets may operate normally, and thus when the fire state ends, power may be stably supplied by the normally operating battery cell sets.

The data center 701 is described only as an example of a system to which power is supplied, and the fire response system is not limited to the data center 701 but is applied to a battery for supplying power to a system requiring power supply.

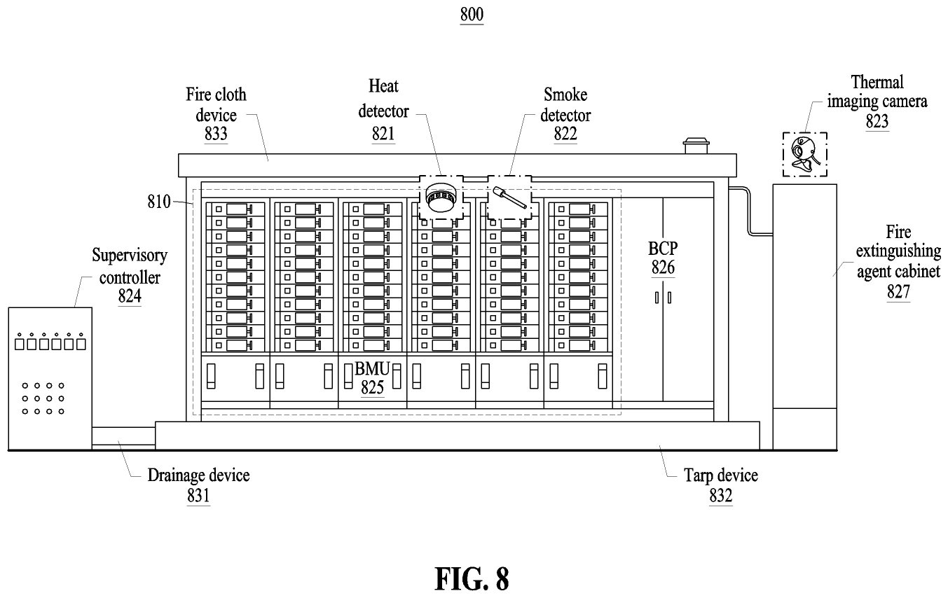

FIG. 8 shows an example of a battery device associated with a fire response system.

Referring to FIG. 8, a battery device 800 for fire response may include a set of battery cells 810, a fire response device, and one or more devices for fire response controlled by the fire response device.

As described above, the fire response device may include a module that detects the occurrence of afire in the battery cell set 810 and performs actions to respond to the occurrence of the fire.

The battery device 800 may be controlled by a server (e.g., the server 120 of FIG. 1) that performs a fire response method (e.g., the example method(s) described herein). As described above, the server may determine a fire hazard condition of the battery cell set 810 and control operations of the fire response device to respond to the fire. In an example, the server may determine a fire condition of the battery cell set 810 based on data received from the fire response device. The server may send control signals to the fire response device to cause the fire response device to perform one or more operations to respond to the set of battery cells 810 that are determined to be on fire (or determined to have a fire hazard condition).

For example, the fire response device of the battery device 800 may include a heat detector 821 that is a fire detection sensor, a smoke detector 822, a thermal imaging camera 823, and a supervisory controller 824.

For example, the fire response device of the battery device 800 may include a battery management unit (BMU) 825 that measures various factors, such as current, voltage, temperature, etc. of the battery cells. For example, the fire response device of the battery device 800 may include a fire extinguishing patch, which may be installed inside a battery connection panel (BCP) 826. For example, the fire response device of the battery device 800 may include a fire extinguishing agent dispensing device. The fire extinguishing agent dispensing device may be a module that controls the dispensing of fire extinguishing agents stored in the fire extinguishing agent cabinet 827.

The apparatus for responding to a fire may be a physical device controlled by the fire response device. The device for responding to a fire may be actuated by a control signal received from the fire response device.

For example, the fire response device of the battery device 800 may include a coolant injection device, and the battery device 800 may include a drainage device 831 controlled by the coolant injection device. The drainage device 831 may perform an action of spraying coolant in response to a control signal received from the coolant injection device.

For example, the fire response device of the battery device 800 may include a waterproof material deployment module for deploying a waterproof material (e.g., a waterproof sheet, a waterproof cloth, a tarp, etc.), and the battery device 800 may include a waterproofing device (e.g., a tarp device 832) controlled by the waterproof material deployment device. In an example, the tarp device 832 may perform an action of placing a tarp onto the set of battery cells 810 in response to a control signal received from the waterproof material deployment module.

For example, the fire response device of the battery device 800 may include a fire cloth placement device, and the battery device 800 may include a fire cloth device 833 controlled by the fire cloth placement device. The fire cloth device 833 may be operable to place a fire cloth onto the set of battery cells 810 in response to a control signal received from the fire cloth placement module.

According to an aspect, there is provided a method of responding to a fire, the method including: monitoring a state of a battery cell set based on a plurality of fire detection sensors; detecting a fire state of the battery cell set based on at least one of the fire detection sensors; and controlling a fire response sequence corresponding to the battery cell set based on triggering conditions corresponding to the fire state. The fire response sequence may include a series of operations including a power cut-off operation, an oxygen cut-off operation, and a cooling operation to extinguish a fire in the battery cell set.

The controlling of the fire response sequence may include: determining whether the triggering conditions respectively corresponding to the power cut-off operation, the oxygen cut-off operation, and the cooling operation included in the fire response sequence are satisfied; and controlling an execution of an operation in the fire response sequence corresponding to a satisfied triggering condition among the triggering conditions.

The controlling of the fire response sequence may include: in response to the fire state of the battery cell set being detected, controlling the power cut-off operation of the battery cell set and the oxygen cut-off operation corresponding to the battery cell set.

The controlling of the fire response sequence may include: when an intensity of the fire state reaches a first threshold intensity, controlling a fire extinguishing patch activation operation in the cooling operation corresponding to the battery cell set.

The controlling of the fire response sequence may include: when the intensity of the fire state reaches a second threshold intensity higher than the first threshold intensity, controlling at least one of a fire extinguishing agent spraying operation or a coolant injection operation in the cooling operation corresponding to the battery cell set.

The controlling of the fire response sequence may include: when a triggering condition for the fire extinguishing patch activation operation in the cooling operation is satisfied, controlling the fire extinguishing patch activation operation; and when a duration of the fire state reaches a threshold time, controlling at least one of the fire extinguishing agent spraying operation or the coolant injection operation in the cooling operation corresponding to the battery cell set.

The intensity of the fire state may be determined based on at least one of a temperature or an amount of smoke around the battery cell set.

The controlling of the fire response sequence may include: controlling the coolant injection operation in the cooling operation corresponding to the battery cell set, based on whether a fire extinguishing agent corresponding to the battery cell set remains.

The cooling operation may include a waterproof cloth arrangement operation and the coolant injection operation, and the controlling of the fire response sequence may include controlling the coolant injection operation based on whether the waterproof cloth arrangement operation corresponding to the battery cell set is executed.

The battery cell set may include at least one of a first unit including at least one battery cell, a second unit including at least one first unit, or a third unit including at least one second unit.

The oxygen cut-off operation may include at least one of a flame-retardant cloth arrangement operation or the fire extinguishing agent spraying operation.

The cooling operation may include at least one of the fire extinguishing patch activation operation, the fire extinguishing agent spraying operation, the waterproof cloth arrangement operation, or the coolant injection operation.

The triggering conditions may include at least one of a triggering condition corresponding to the detection of the fire state, a triggering condition corresponding to the intensity of the fire state, a triggering condition corresponding to the duration of the fire state, or a triggering condition corresponding to whether a preceding operation in the fire response sequence is executed.

The fire detection sensors may include an internal sensor of the battery cell set, a heat detection sensor, a smoke detection sensor, and a thermal imaging camera.

According to another aspect, there is provided a server including a processor. The processor may be configured to: monitor a state of a battery cell set based on a plurality of fire detection sensors; detect a fire state of the battery cell set based on at least one of the fire detection sensors; and control a fire response sequence corresponding to the battery cell set, based on triggering conditions corresponding to the fire state. The fire response sequence may include a series of operations including a power cut-off operation, an oxygen cut-off operation, and a cooling operation to extinguish a fire in the battery cell set.

For controlling the fire response sequence, the processor may be configured to: determine whether the triggering conditions respectively corresponding to the power cut-off operation, the oxygen cut-off operation, and the cooling operation included in the fire response sequence are satisfied; and control an execution of an operation in the fire response sequence corresponding to a satisfied triggering condition among the triggering conditions.

For controlling the fire response sequence, the processor may be configured to: in response to the fire state of the battery cell set being detected, control the power cut-off operation of the battery cell set and the oxygen cut-off operation corresponding to the battery cell set.

For controlling the fire response sequence, the processor may be configured to: when an intensity of the fire state reaches a first threshold intensity, control a fire extinguishing patch activation operation in the cooling operation corresponding to the battery cell set.

For controlling the fire response sequence, the processor may be configured to: when the intensity of the fire state reaches a second threshold intensity higher than the first threshold intensity, control at least one of a fire extinguishing agent spraying operation or a coolant injection operation in the cooling operation corresponding to the battery cell set.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method comprising:
monitoring, based on sensing data from a plurality of fire hazard detection sensors configured to detect a fire hazard, a state of a plurality of battery cell sets in a battery system of a data center;
detecting, based on the monitoring, a fire hazard state of at least one battery cell set of the plurality of battery cell sets; and
controlling, by a controller and based on at least one triggering condition associated with the fire hazard state, a fire hazard response sequence corresponding to the at least one battery cell set,
wherein the fire hazard response sequence comprises a series of operations comprising a power cut-off operation, an oxygen cut-off operation, and a cooling operation, and
wherein the cooling operation comprises injecting, by the controller, a coolant in an inner portion of the battery system.

2. The method of claim 1, wherein the controlling of the fire hazard response sequence comprises:
determining whether a plurality of triggering conditions respectively corresponding to the power cut-off operation, the oxygen cut-off operation, and the cooling operation comprised in the fire hazard response sequence are satisfied; and
controlling, by the controller, an execution of an operation of the fire hazard response sequence corresponding to a satisfied triggering condition among the plurality of triggering conditions, and
wherein the cooling operation comprises moving, by the controller, a waterproof sheet to surround at least the inner portion of the battery system, wherein the inner portion of the battery system surrounds at least a portion of the at least one battery cell set.

3. The method of claim 1, wherein the controlling of the fire hazard response sequence comprises:
in response to the fire hazard state of the at least one battery cell set being detected, controlling a power cut-off operation of the at least one battery cell set and an oxygen cut-off operation of the at least one battery cell set.

4. The method of claim 1, wherein the controlling of the fire hazard response sequence comprises:
based on an intensity of the fire hazard state reaching a first threshold intensity, controlling a fire extinguishing patch activation operation of the cooling operation for the at least one battery cell set.

5. The method of claim 4, wherein the controlling of the fire hazard response sequence comprises:
based on the intensity of the fire hazard state reaching a second threshold intensity higher than the first threshold intensity, controlling at least one of a fire extinguishing agent spraying operation associated with the at least one battery cell set or a coolant injection operation associated with the at least one battery cell set.

6. The method of claim 1, wherein the controlling of the fire hazard response sequence comprises:
based on a triggering condition for a fire extinguishing patch activation operation of the cooling operation being satisfied, controlling the fire extinguishing patch activation operation; and
based on a duration of the fire hazard state reaching a threshold time, controlling at least one of a fire extinguishing agent spraying operation associated with the at least one battery cell set or a coolant injection operation associated with the at least one battery cell set.

7. The method of claim 1, wherein an intensity of the fire hazard state is determined based on at least one of a temperature or an amount of smoke around the at least one battery cell set.

8. The method of claim 1, wherein the controlling of the fire hazard response sequence comprises:
controlling, based on whether a fire extinguishing agent corresponding to the battery cell set remains, the injecting of the coolant in the inner portion of the battery system.

9. The method of claim 1, wherein the cooling operation comprises a waterproof arrangement operation and a coolant injection operation,
wherein the controlling of the fire hazard response sequence comprises:
controlling the coolant injection operation based on whether the waterproof arrangement operation corresponding to the battery cell set is executed.

10. The method of claim 1, wherein a battery cell set comprises at least one of:
a first unit comprising at least one battery cell;
a second unit comprising at least one first unit; or
a third unit comprising at least one second unit.

11. The method of claim 1, wherein the oxygen cut-off operation comprises at least one of:
a flame-retardant cloth arrangement operation; or
a fire extinguishing agent spraying operation.

12. The method of claim 1, wherein the cooling operation comprises at least one of:
a fire extinguishing patch activation operation;
a fire extinguishing agent spraying operation;
a waterproof cloth arrangement operation; or
a coolant injection operation.

13. The method of claim 1, wherein the at least one triggering condition comprises at least one of:
a triggering condition corresponding to the detection of the fire hazard state;
a triggering condition corresponding to an intensity of the fire hazard state;
a triggering condition corresponding to a duration of the fire hazard state; or
a triggering condition corresponding to whether a preceding operation in the fire hazard response sequence is executed.

14. The method of claim 1, wherein the plurality of fire hazard detection sensors comprise:
an internal sensor of the at least one battery cell set;
a heat detection sensor;
a smoke detection sensor; and
a thermal imaging camera.

15. A system comprising:
a plurality of fire hazard detection sensors configured to detect a fire hazard;
a battery system, of a data center, comprising a plurality of battery cell sets;
a controller; and
a waterproof sheet configured to be movable by a control signal of the controller; and
memory storing instructions that, when executed by the controller, cause the system to:
monitor, based on sensing data from the plurality of fire hazard detection sensors, a state of the plurality of battery cell sets in the battery system;
detect, based on monitoring the state of the plurality of battery cell sets, a fire hazard state of at least one battery cell set of the plurality of battery cell sets; and
control, based on at least one triggering condition associated with the fire hazard state, a fire hazard response sequence corresponding to the at least one battery cell set,
wherein the fire hazard response sequence comprises a series of operations comprising a power cut-off operation, an oxygen cut-off operation, and a cooling operation, and
wherein the cooling operation comprises injecting, by the controller, a coolant in an inner portion of the battery system.

16. The system of claim 15, wherein the plurality of fire hazard detection sensors comprise:
an internal sensor of the at least one battery cell set;
a heat detection sensor;
a smoke detection sensor; and
a thermal imaging camera.

17. The system of claim 15, wherein the instructions, when executed by the controller, cause the system to control the fire hazard response sequence by:
determining whether the plurality of triggering conditions respectively corresponding to the power cut-off operation, the oxygen cut-off operation, and the cooling operation comprised in the fire hazard response sequence are satisfied; and
controlling an execution of an operation of the fire hazard response sequence corresponding to a satisfied triggering condition among the plurality of triggering conditions, and
wherein the cooling operation comprises moving, by the controller, a waterproof sheet to surround at least the inner portion of the battery system, wherein the inner portion of the battery system surrounds at least a portion of the at least one battery cell set.

18. The system of claim 15, wherein the instructions, when executed by the controller, cause the system to control the fire hazard response sequence by:
in response to the fire hazard state of the at least one battery cell set being detected, controlling a power cut-off operation of the at least one battery cell set and an oxygen cut-off operation of the at least one battery cell set.

19. The system of claim 15, wherein the instructions, when executed by the controller, cause the system to control the fire hazard response sequence by:
based on an intensity of the fire hazard state reaching a first threshold intensity, controlling a fire extinguishing patch activation operation of the cooling operation for the at least one battery cell set.

20. The system of claim 19, wherein the instructions, when executed by the controller, cause the system to control the fire hazard response sequence by:
based on the intensity of the fire hazard state reaching a second threshold intensity higher than the first threshold intensity, controlling at least one of a fire extinguishing agent spraying operation associated with the at least one battery cell set or a coolant injection operation associated with the at least one battery cell set.
